(19) United States
(12) Patent Application Publication
(10) Pub. No.: US 2006/0092200 A1
(43) Pub. Date: May 4, 2006

(54) Inkjet image output system

(75) Inventors: Yung-Chuan Wu, Pingjhen City (TW); Bo-Hsiang Wang, Taiping City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AVISION INC.

(21) Appl. No.: 11/211,971

(22) Filed: Aug. 25, 2005

(30) Foreign Application Priority Data
Oct. 29, 2004 (TW) 93133095

(51) Int. Cl. B41J 29/38

(52) U.S. Cl. 347/9

(57) ABSTRACT

An inkjet image output system including a control unit and a number of inkjet printing units is disclosed. The control unit is for receiving a first image datum, then outputting a print datum accordingly. The inkjet printing units print an image corresponding to the print datum under the control of the control unit. The image is printed by at least two of the inkjet printing units.

This application claims the benefit of Taiwan application Serial No. 93133095, filed Oct. 29, 2004, the subject matter of which is incorporated herein by reference.

### BACKGROUND OF THE INVENTION

1. Field of the Invention

The invention relates in general to an image output system, and more particularly to an inkjet image output system.

2. Description of the Related Art

With the coming of digital imaging, conventional photo shops are gradually changed to digital photo shops to meet the increasing needs of the users of digital imaging and provide a convenient output channel for digital images.

According to the output methods of digital image processing equipment, the digital image processing equipment used in ordinary digital photo shops can be categorized as the laser type, the wet type and the inkjet type.

The laser type digital image processing equipment has the lowest costs and is most affordable to photo shop owners. Compared with the inkjet type digital image processing equipment in terms of overall frame, the photo printed by the color laser digital image processing equipment has a darker color saturation, fewer gradual levels and poorer color levels. The photo printed by the laser digital image processing equipment does not have good performance and looks more like a printed matter than a photo.

Conventional wet digital image processing equipment has the highest printing speed, and the highest price and maintenance in the meantime. A wet digital image processing equipment costs about USD 160,000 in Taiwan, and not every photo shop owner affords to pay such a high price in terms of purchase and maintenance. Besides, the conventional wet image processing equipment uses chemicals to process the photos. The chemicals produce smelly odors and deteriorate the quality in the work environment. Worse than that, a large amount of the waste water is produced, which is indeed very environment unfriendly. Moreover, the chemical agents used for processing photos can create chemical reactions only under certain conditions, such as under a particular temperature for instance, so the conventional wet image processing equipment cannot process photos immediately after activation. It takes quite a while for the chemical agents to meet the required conditions so that the processing of photos can be started. This is very inconvenient to the user.

The typical product of the inkjet printing digital image processing equipment is the dDP-411 model digital dry photo-printer manufactured by the Noritsu Koki Co., Ltd. of Japan. Ordinary inkjet printing printers for household purpose can only print about 60 4×6 photos per hour, and are the requirements of commercial digital photo shop in terms of speed. To meet the speed requirement of the digital photo shop, the dDP-411 model digital dry photo-printer has a wider printer head than ordinary household purpose inkjet printing printers. However, the wider the printer head, the higher the price and the lower the pass rate. Despite the dDP-411 model digital dry photo-printer has a wider printer head, the printing speed can only be as high as 310 4×6 photos per hour. Suppose the digital dry photo-printer works 8 hours per day, only 2400 4×6 photos can be printed. Such printing speed cannot meet the needs of a larger photo shop.

### SUMMARY OF THE INVENTION

It is therefore an object of the invention to provide an inkjet image output system with the advantages of high printing speed, high printing quality and low price.

According to the object of the invention, an inkjet image output system including a control unit and plural inkjet printing units is provided. The control unit is for receiving a first image datum, then outputting a print datum accordingly. The plural inkjet printing units print an image corresponding to the print datum under the control of the control unit. The image is printed by at least two of the inkjet printing units.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram of an inkjet image output system according to a first embodiment of the invention;

FIG. 2 is a block diagram of an inkjet printing unit of the inkjet image output system in FIG. 1;

FIG. 3 is a diagram of an inkjet image output system according to a second embodiment of the invention;

FIG. 4 is a diagram of an inkjet image output system according to a third embodiment of the invention;

FIG. 5 is a block diagram of an inkjet printing unit of inkjet image output system in FIG. 4; and

FIG. 6 is a diagram of another inkjet image output system according to a third embodiment of the invention.

### DETAILED DESCRIPTION OF THE INVENTION

### FIRST EMBODIMENT

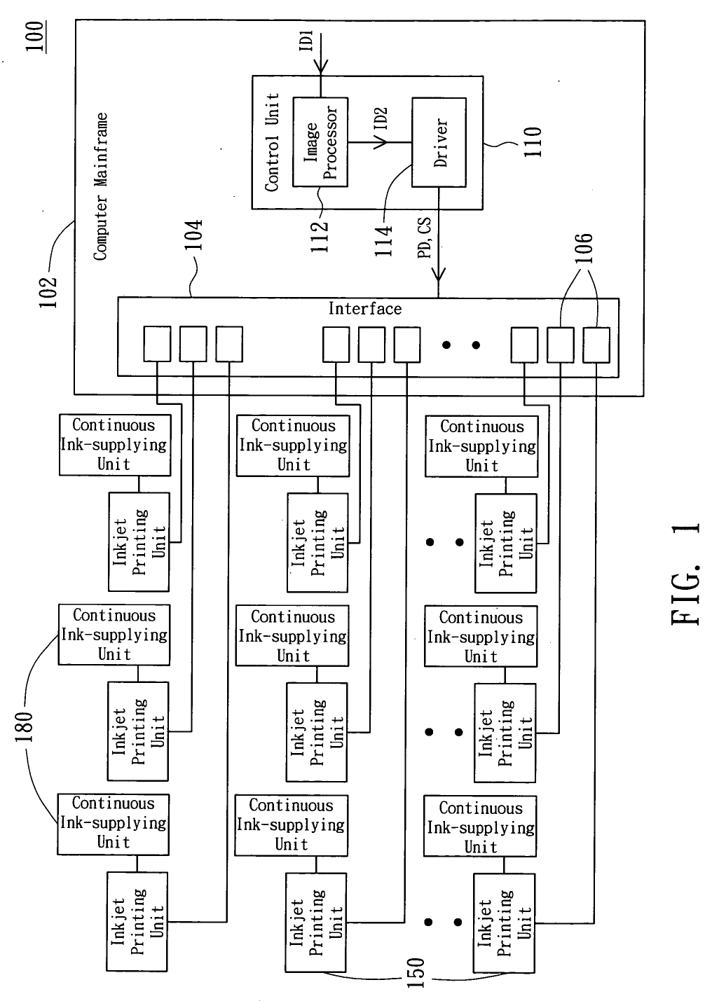

Referring to FIG. 1, a diagram of an inkjet image output system according to a first embodiment of the invention is shown. An inkjet image output system 100 includes a control unit 110, a number of inkjet printing units 150 and a number of continuous ink-supplying units 180. The control unit 110 is disposed in a computer mainframe 102 for receiving first image data ID1. The source of the first image data ID1 can be a device such as a digital camera, a scanner, a disc or an optical disc that can be inputted via the computer mainframe 102. The computer mainframe 102 has an interface 104. The interface 104 is a USB extension card, having a number of mainframe connecting ports 106 for an external hardware to be coupled to the computer mainframe 102. The interface 104 can communicate with the control unit 110 via a PCI slot.

The control unit 110 includes an image processor 112 and a driver 114. The image processor 112 processes the first image data ID1 received by the control unit 110 and then outputs second image data ID2 accordingly. The driver 114 outputs print data PD according to second image data ID2. The print data PD can include sub-image data of a number of photos or include at least sub-image data of a large poster for instance. The driver 114 further outputs a control signal CS to control the inkjet printing units 150.

The inkjet printing units 150 are respectively coupled to the mainframe connecting ports 106. Each inkjet printing unit 150 is an inkjet printer. Under the control of the control signal CS, at least two of the inkjet printing units 150 are selected to print the corresponding image of the print data PD.

The required ink of each inkjet printing unit 150 is provided by a continuous ink-supplying unit 180 coupled to the inkjet printing unit 150 as shown in FIG. 1. Each continuous ink-supplying unit 180 can have a number of ink cartridges for containing inks of various colors. Each ink cartridge is preferably to have a level detector disposed within for detecting the ink level within the ink cartridge. The level detector sends a warning signal to remind the user that the ink cartridge needs to be refilled when the ink of the ink cartridge reaches a pre-set level.

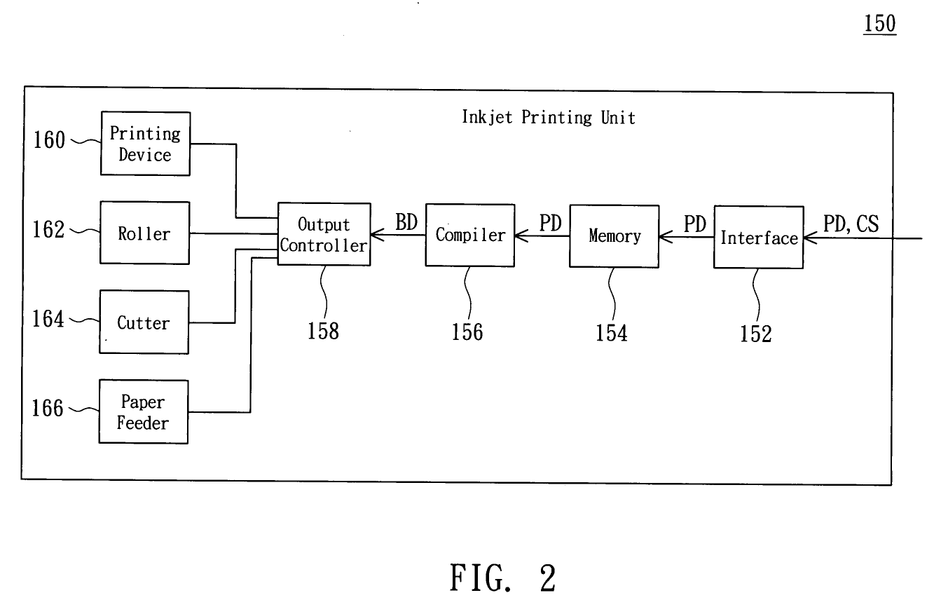

Referring to FIG. 2, a block diagram of an inkjet printing unit of the inkjet image output system in FIG. 1 is shown. Each inkjet printing unit 150 includes an interface 152, a memory 154, a compiler 156, an output controller 158, a printing device 160, a roller 162, a cutter 164 and a paper feeder 166. The interface 152 is used as a printer connecting port. The inkjet printing units 150 are respectively connected to the mainframe connecting ports 106 via the interface 152. The memory 154 stores the print data PD outputted by the driver 114. The memory 154 further stores a bitmap of characters or a vector of characters, and printing bitmap data ready to print out.

The compiler 156 is electrically connected to the memory 154 for the print data PD to be compiled into bitmap data BD. The format of the bitmap data BD is a data format can be printed by the printing device 160 accordingly. The output controller 158 is coupled to the compiler 156 to control a printing device 160, a roller 162, a cutter 164 and a paper feeder 166. The printing device 160 includes necessary mechanisms for printing a photo or a poster such as an inkjet printer head and an ink cartridge carrier for instance. The roller 162 receives a roller paper. The cutter 164 cuts the roller paper. The paper feeder 166 provides a printing media of ready cut papers.

When the inkjet printing unit 150 receives the print data PD and the control signal CS and is ready to print the print data PD including plural photos or at least sub-image data of a large poster, the inkjet printing unit 150, first of all, compiles the print data PD into bitmap data BD via the compiler 156. Then, the inkjet printing unit 150 controls the printing device 160, the roller 162, the cutter 164 and the paper feeder 166 via an output controller 158, so that the bitmap data BD can be printed onto the roller paper or a printing medium provided by the paper feeder 166. The cutter 164 is used to automatically cut the photo or poster printed on the roller paper to complete the printing task when the bitmap data BD is printed onto the roller paper.

Refer to FIG. 1 again. It can be seen from above disclosure that the inkjet image output system 100 controls the plural inkjet printing units 150 via the control unit 110, so that the corresponding image of the print data PD is printed by at least two of inkjet printing units 150. For example, suppose that the inkjet image output system 100 includes 15 inkjet printing units 150 each being capable of printing one 4×6 photo per minute and that the control signal CS selects all of the 15 inkjet printing units 150 to print the print data PD at the same time, then the inkjet image output system 100 can print 900 4×6 photos per hour. Therefore, the inkjet image output system 100 is capable of printing 7200 4×6 photos if the inkjet image output system 100 works 8 hours per day. Such printing speed would suffice to satisfy the needs of a digital photo processing shop.

The embodiment uses the inkjet printing print unit to print photos. Compared with conventional laser digital image processing equipment, the photo printed by the inkjet image output system 100 of the embodiment has a higher color saturation, more gradual levels and richer color levels.

In terms of the cost of each photo, the inkjet image output system 100 according to the embodiment is much lower than the conventional wet digital image processing equipment. In terms of overall system costs, main costs of the inkjet image output system 100 are the computer mainframe 102 and a number of inkjet printing units 150. In Taiwan, a good quality computer mainframe P4 costs only about US$ 1,000, and a high-priced inkjet printer costs only one or a few hundred US dollars. Therefore, the cost of the inkjet image output system 100 according to the embodiment is much lower than any digital image processing equipment currently used in digital photo shops. So, the purchase and maintenance of digital image processing equipment are within the ability of a photo shop. Once having its own digital image developing equipment, a photo shop does not need to send the digital image data to a digital image processing center for processing, not only saving the costs and time of delivery, but also creating the advantage of instant service.

### SECOND EMBODIMENT

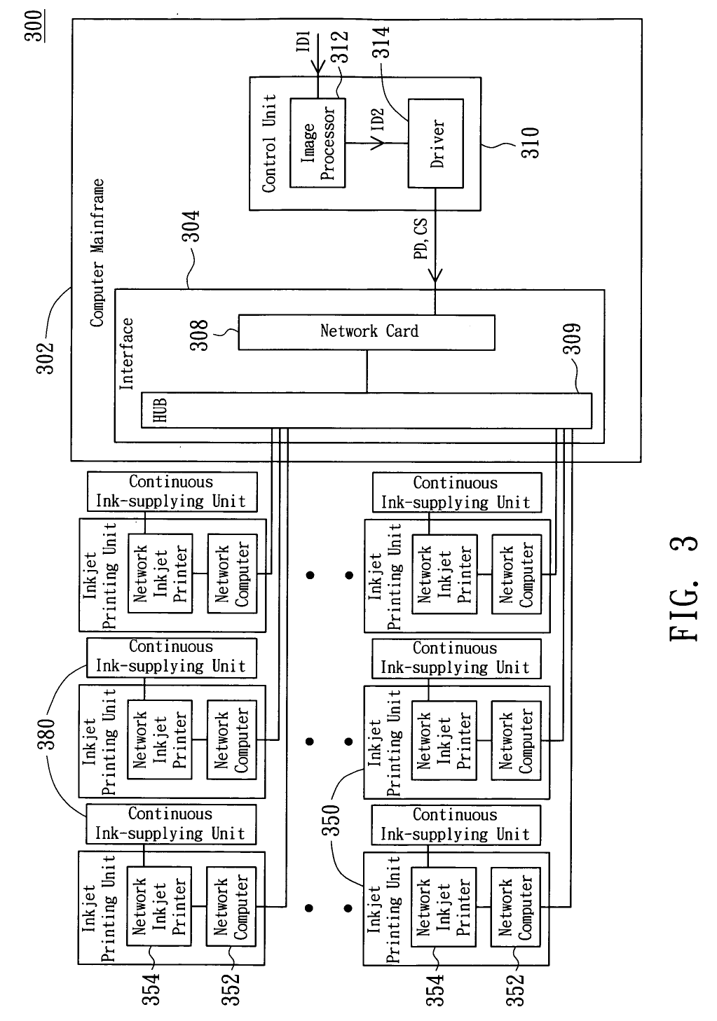

Referring to FIG. 3, a diagram of an inkjet image output system according to a second embodiment of the invention is shown. An inkjet image output system 300 includes a control unit 310, a number of inkjet printing units 350 and a number of continuous ink-supplying units 380. The control unit 310 is disposed in a computer mainframe 302 to receive first image data ID1. The computer mainframe 302 has an interface 304. The interface 304 is a network card 308 and has a HUB 309 for an external hardware to be coupled to a computer mainframe 302.

Each inkjet printing unit 350 is coupled to the HUB 309. Each inkjet printing unit 350 includes a network computer 352 and a network inkjet printer 354. The network computer 352 is coupled to the network inkjet printer 354. Under the control of the control signal CS, the network inkjet printers 354 of at least two of the inkjet printing units 350 are selected to print the corresponding image of the print data PD. The ink required by each inkjet printing unit 350 can be provided by the continuous ink-supplying units 380 for instance. The continuous ink-supplying units 380 are coupled to the network inkjet printer 354 of the inkjet printing unit 350.

According to the second embodiment, the print data PD and the control signal CS are outputted to a number of inkjet printing units 350 via the network card 308 and the HUB 309, so that the corresponding image of the print data PD can be printed by the network inkjet printers 354 of at least two of the inkjet printing units 350 under the control of the control signal CS. Therefore, the printing speed of the inkjet image output system 300 of the second embodiment would suffice to meet the needs of a digital photo shop.

### THIRD EMBODIMENT

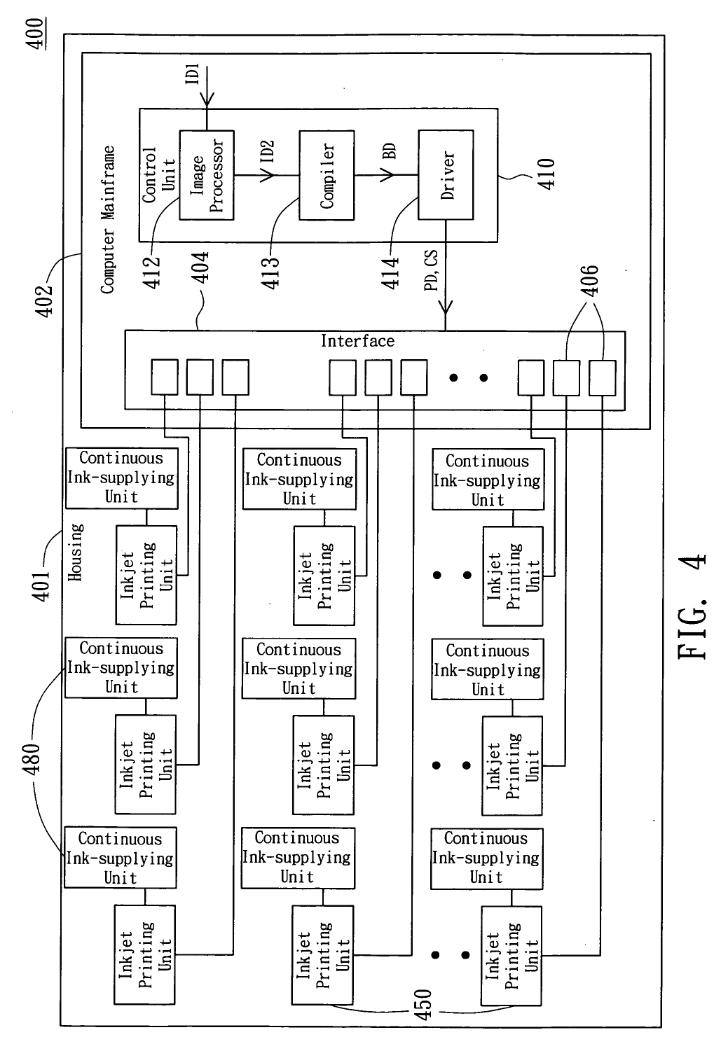

Referring to FIG. 4, a diagram of an inkjet image output system according to a third embodiment of the invention is shown. An inkjet image output system 400 includes a housing 401, a control unit 410, a number of inkjet printing units 450 and a number of continuous ink-supplying units 480. The control unit 410 is disposed in a computer mainframe 402 to receive first image data ID1. The computer mainframe 402 has an interface 404. The interface 404 is a USB extension card and has a number of mainframe connecting ports 406 for an external hardware to be coupled to the computer mainframe 402. The computer mainframe 402, the inkjet printing units 450 and the continuous ink-supplying units 480 are disposed in the housing 401.

The control unit 410 includes an image processor 412, a compiler 413 and a driver 414. The image processor 412 processes the first image data ID1 received by the control unit 410 then outputs second image data ID2 accordingly. The compiler 413 is electrically connected to the image processor 412 for the second image data ID2 to be compiled into bitmap data BD. The driver 414 outputs print data PD according to the bitmap data BD. The print data PD includes sub-image data of a number of photos or at least sub-image data of a large poster for instance. The driver 414 further outputs a control signal CS to control the inkjet printing units 450.

Each of the inkjet printing units 450 is respectively coupled to the mainframe connecting port 406. Each inkjet printing unit 450 is an inkjet print module. Under the control of control signal CS, at least two of the inkjet printing units 450 are selected to print the corresponding image of the print data PD. The required ink of the inkjet printing unit 450 is provided by the continuous ink-supplying unit 480 coupled to the inkjet printing unit 450 as shown in FIG. 4.

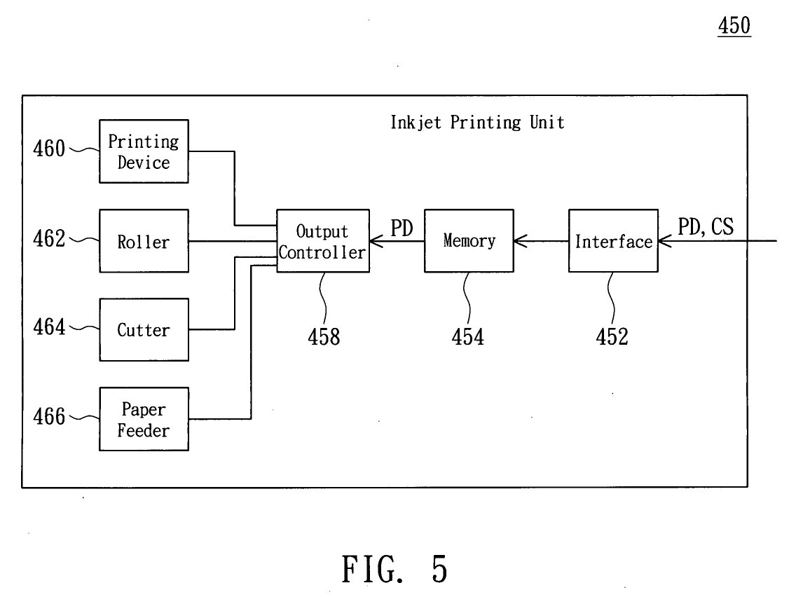

Referring to FIG. 5, a block diagram of an inkjet printing unit of inkjet image output system in FIG. 4 is shown. Each inkjet printing unit 450 includes an interface 452, a memory 454, an output controller 458, a printing device 460, a roller 462, a cutter 464 and a paper feeder 466. The interface 452 is coupled to the mainframe connecting port 406. The memory 454 stores the print data PD outputted by the driver 414. The output controller 458 is coupled to the memory 454 to control the printing device 460, the roller 462, the cutter 464 and the paper feeder 466. The roller 462 receives a roller paper. The cutter 464 cuts the roller paper. The paper feeder 466 provides a ready-cut printing medium.

Under the control of the output controller 458 of the inkjet printing unit 450, the print data PD can be directly printed on the roller paper of the roller 462 or a printing medium provided by the paper feeder 466 when the inkjet printing unit 450 receives the print data PD and the control signal CS and is ready to print the print data PD including plural photos or at least sub-image data of a large poster. Moreover, the cutter 464 is used to automatically cut the printed photo on the roller paper to complete the task of print a photo or a poster when the print data PD print is printed on the roller paper.

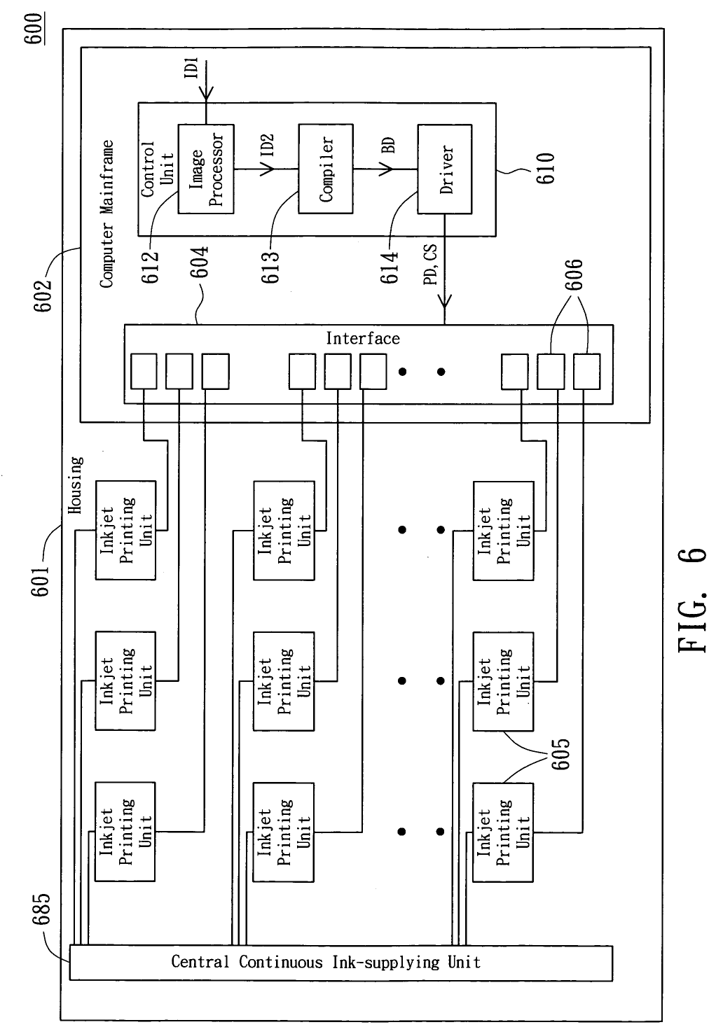

It is noteworthy that, the inkjet image output system 400 of FIG. 4 is exemplified by using plural continuous ink-supplying units 480 to continually supply inkjet printing units 450 with required ink. However, there is no restriction regarding the way to provide individual inkjet printing unit with required ink. Referring to FIG. 6, a diagram of another inkjet image output system according to a third embodiment of the invention is shown. Compared with the inkjet image output system 400 of FIG. 4, the inkjet image output system 600 of FIG. 6 only includes a central continuous ink-supplying unit 685, and is coupled to respective inkjet printing unit for continually supplying individual inkjet printing unit 650 with required ink.

Refer to FIG. 1, FIG. 2, FIG. 4 and FIG. 5 at the same time. Compared with the first embodiment, the present embodiment uses a housing 401 to envelop all components of the inkjet image output system 400 for the inkjet image output system 400 to have a one-piece structure. Besides, the inkjet image output system 400 of the embodiment has a compiler 413 disposed in the control unit 410. Therefore, all the ready-to-print data can be compiled via the compiler 413 into a data format that the inkjet printing unit 450 can print accordingly to achieve the object of the invention.

The inkjet image output system disclosed in above embodiments of the invention has the advantages of high printing speed, high printing quality and low price.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An inkjet image output system, comprising:
a control unit for receiving a first image datum, and then outputting a print datum accordingly; and
a plurality of inkjet printing units which print the print datum under the control of the control unit, wherein the print datum is printed by at least two of the inkjet printing units.

2. The system according to claim 1, wherein the print datum comprises sub-image data of a plurality of photos.

3. The system according to claim 1, wherein the print datum comprises a sub-image datum of a large poster.

4. The system according to claim 1, wherein the control unit comprises:
an image processor for processing the first image datum received by the control unit and then outputting a second image datum accordingly; and
a driver electrically connected to the image processor, wherein the driver, which outputs the print datum according to the second image datum, further outputs a control signal for selecting at least two of the inkjet printing units to print the print datum.

5. The system according to claim 4, wherein each of the inkjet printing units comprises:
an interface for communicating with the control unit;
a memory electrically connected to the interface for storing the print datum;
a compiler electrically connected to the memory for compiling the print datum into a bitmap datum;
an output controller electrically connected to the compiler; and
a printing device which prints the bitmap datum under the control of the output controller.

6. The system according to claim 1, wherein each of the inkjet printing units is an inkjet printer, while the control unit is disposed in a computer mainframe.

7. The system according to claim 6, wherein each of the inkjet printers has a printer connecting port, the computer mainframe has a plurality of mainframe connecting ports, and the inkjet printers are connected to the mainframe connecting ports via the printer connecting ports.

8. The system according to claim 1, wherein each of the inkjet printing units comprises a network inkjet printer.

9. The system according to claim 1, wherein the control unit comprises:
an image processor for processing the first image datum received by the control unit and then outputting a second image datum accordingly;
a compiler, electrically connected to the image processor, for compiling the second image datum into a bitmap datum; and
a driver, electrically connected to the compiler, for outputting the print datum according to the bitmap datum and outputting a control signal for selecting at least two of the inkjet printing units to print the print datum.

10. The system according to claim 9, wherein each of the inkjet printing units comprises:
an interface for communicating with the control unit;
a memory electrically connected to the interface for storing the print datum;
an output controller electrically connected to the memory; and
a printing device for printing the print datum under the control of the output controller.

11. The system according to claim 10, wherein each of the inkjet printing units is an inkjet print module.

12. The system according to claim 1, wherein the system further comprises a housing for enveloping the control unit and the inkjet printing units.

13. The system according to claim 1, wherein the system further comprises a plurality of continuous ink-supplying units for continually supplying the inkjet printing units with required ink.

14. The system according to claim 1, wherein the system further comprises a central continuous ink-supplying unit for continually supplying the inkjet printing units with required ink.

15. The system according to claim 1, wherein each of the inkjet printing units comprises a roller for receiving a roller paper, and each of the inkjet printing units prints the image onto the roller paper.

16. The system according to claim 15, wherein each of the inkjet printing units further comprises a cutter for cutting the roller paper.
